(19) United States
(12) Patent Application Publication
(10) Pub. No.: US 2026/0291396 A1
(43) Pub. Date: Sep. 24, 2026

(54) SWITCHING CONTROL CIRCUIT AND POWER SUPPLY CIRCUIT

(71) Applicant: FUJI ELECTRIC CO., LTD., Kawasaki-shi (JP)

(72) Inventors: Hiroyasu KATAOKA, Yokohama-city (JP); Sakuei TAKAHASHI, Toda-city (JP); Hironobu SHIROYAMA, Matsumoto-city (JP)

(73) Assignee: FUJI ELECTRIC CO., LTD., Kawasaki-shi (JP)

(21) Appl. No.: 19/464,978

(22) Filed: Jan. 30, 2026

(30) Foreign Application Priority Data
Mar. 18, 2025 (JP) 2025-043017

(51) Int. Cl. H02M 3/335

(52) U.S. Cl. CPC H02M 3/33569

(57) ABSTRACT

A switching control circuit for a power supply circuit including a transformer and a transistor controlling an inductor current flowing through the transformer. The switching control circuit includes: a driver circuit driving the transistor, based on a feedback voltage corresponding to an output voltage and an current flowing through the transistor; a first detection circuit detecting whether the current flowing through the transistor is greater than a first current; a second detection circuit detecting whether a load current flowing through a load of the power supply circuit is greater than a second current; and a control circuit controlling the driver circuit to stop switching the transistor, when the inductor current flowing through the transistor has been greater than the first current for a first time period, or when the load current has been greater than the second current for a second time period longer than the first time period.

### CROSS-REFERENCE TO RELATED APPLICATIONS

The present application claims priority pursuant to 35 U.S.C. §119 from Japanese patent application number 2025-043017, filed on Mar. 18, 2025, the entire disclosure of which is hereby incorporated by reference herein.

### BACKGROUND

### Technical Field

The present disclosure relates to a switching control circuit and a power supply circuit.

### Description of the Related Art

There are isolated power supply circuits comprising a transformer that includes a primary coil a secondary coil (for example, Japanese Patent Application Publication No. 2001-292572).

The power supply circuits include those configured to stop operating after detecting, on the secondary side, that a load current flowing through a load exceeds a predetermined value and has been in an overload state for a predetermined time period. However, in order to detect, on the secondary side, that the load has been in the overload state for the predetermined time period, a capacitor having a large capacitance value is needed in general, which may result in an increase in the circuit size of a power supply circuit.

### SUMMARY

A first aspect of the present disclosure is a switching control circuit for a power supply circuit that generates an output voltage at a target level from an input voltage inputted thereto, the power supply circuit having a load, the power supply circuit including a transformer including a primary coil and a secondary coil, and a transistor configured to control an inductor current flowing through the primary coil, the switching control circuit being configured to drive the transistor, the switching control circuit comprising: a driver circuit configured to drive the transistor, based on a feedback voltage corresponding to the output voltage and a current flowing through the transistor; a first detection circuit configured to detect whether the current flowing through the transistor is greater than a first current; a second detection circuit configured to detect whether a load current flowing through the load of the power supply circuit is greater than a second current; and a control circuit configured to control the driver circuit so as to stop switching the transistor, in response to a state in which the current flowing through the transistor is greater than the first current having continued for a first time period, or a state in which the load current is greater than the second current having continued for a second time period longer than the first time period.

A second aspect of the present disclosure is a power supply circuit configured to generate an output voltage at a target level from an input voltage inputted thereto, the power supply circuit having a load, the power supply circuit comprising: a transformer including a primary coil and a secondary coil; a transistor configured to control an inductor current flowing through the primary coil; a switching control circuit configured to drive the transistor, the switching control circuit including a driver circuit configured to drive the transistor, based on a feedback voltage corresponding to the output voltage and a current flowing through the transistor, a first detection circuit configured to detect whether the current flowing through the transistor is greater than a first current, and a second detection circuit configured to detect whether a load current flowing through the load of the power supply circuit is greater than a second current, a control circuit configured to control the driver circuit so as to stop switching the transistor, in response to a state in which the current flowing through the transistor is greater than the first current having continued for a first time period, or a state in which the load current is greater than the second current having continued for a second time period longer than the first time period.

### BRIEF DESCRIPTION OF THE DRAWINGS

FIG. 1 is a diagram illustrating a configuration example of an AC-DC converter 10.

FIG. 2 is a diagram illustrating a configuration example of a control IC 32.

FIG. 3 is a diagram illustrating a configuration example of a detection circuit 52.

FIG. 4 is a diagram illustrating an operation example of a comparator 206 and a timer 207.

FIG. 5 is a diagram illustrating an operation example of a light-emitting diode 327 and a phototransistor 41.

### DETAILED DESCRIPTION

At least following matters will become apparent from the descriptions of the present description and the accompanying drawings. The same or equivalent constituent elements, members, and the like illustrated in the drawings are given the same reference numerals, and repetitive description is omitted as appropriate.

### Embodiments

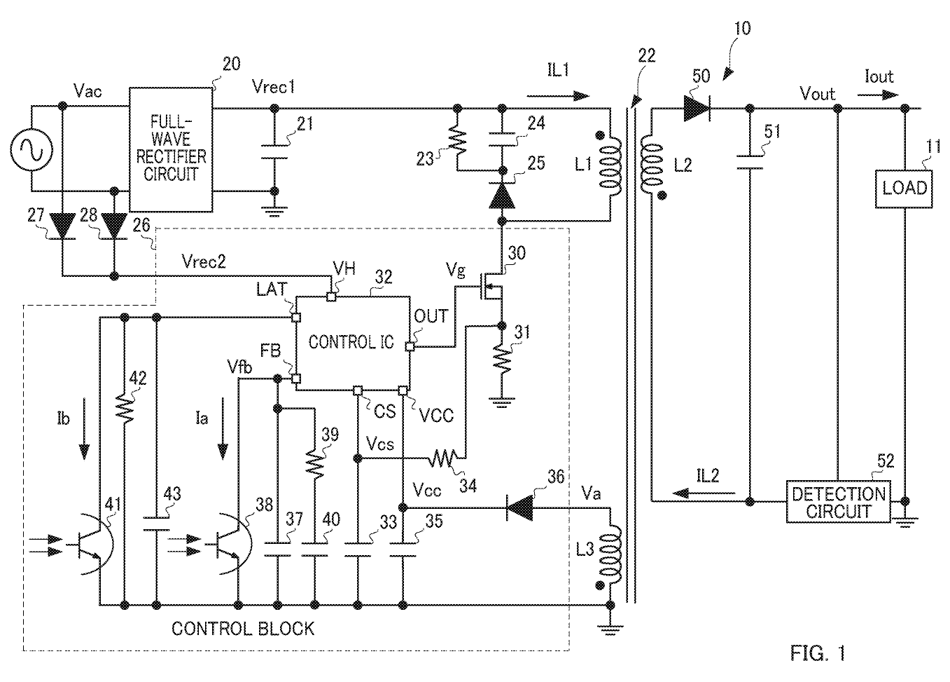

FIG. 1 is a diagram illustrating a configuration example of an AC-DC converter 10 which is an embodiment of the present disclosure. The AC-DC converter 10 is a power supply circuit that generates an output voltage Vout at a target level from an alternating current (AC) voltage Vac of a commercial power supply. Note that the AC voltage Vac corresponds to an "input voltage".

### Overview of AC-DC converter 10

The AC-DC converter 10 includes a full-wave rectifier circuit 20, capacitors 21, 24, 51, a transformer 22, a resistor 23, diodes 25, 27, 28, 50, a control block 26, and a detection circuit 52. A load 11 is a load (for example, a light emitting diode) connected to the AC-DC converter 10, to be supplied with power by the AC-DC converter 10, and is applied with the output voltage Vout. Note that the current flowing through the load 11 is referred to as load current Iout.

The full-wave rectifier circuit 20 full-wave rectifies the predetermined AC voltage Vac, which is an input voltage inputted thereto, and applies a resultant voltage, as a voltage Vrec1, to a primary coil L1 of the transformer 22, the capacitors 21, 24, and the resistor 23. The capacitor 21 smooths the voltage Vrec1. Note that the AC voltage Vac is a voltage with an effective value in a range of 100 to 240 V and a frequency in a range of 50 to 60 Hz, for example.

The transformer 22 includes the primary coil L1 provided on the input side, a secondary coil L2 magnetically coupled to the primary coil L1, and an auxiliary coil L3 magnetically coupled to the secondary coil L2. Here, the secondary coil L2 and the auxiliary coil L3 are formed by winding such that the voltages generated across the secondary coil L2 and the auxiliary coil L3 are opposite in polarity to the voltage generated across the primary coil L1. Further, the primary coil L1 and the auxiliary coil L3 are connected to the input side (primary side), and the secondary coil L2 is connected to the output side (secondary side).

The resistor 23, the capacitor 24, and the diode 25 configure a snubber circuit. The snubber circuit suppresses a surge voltage caused by a leakage inductance of the primary coil L1 when a power transistor 30 (described later) is off, to thereby minimize the damage of the power transistor 30. Further, the snubber circuit is connected in parallel with the primary coil L1. Further, the diode 25 has an anode connected to the high potential side of the power transistor 30 described later and a cathode connected to the resistor 23. Furthermore, the capacitor 24 is connected in parallel with the resistor 23.

The control block 26 controls an inductor current IL1 flowing through the primary coil L1 on the primary side of the transformer 22, to thereby control the voltage generated at the secondary coil L2 on the secondary side of the transformer 22. As result, the output voltage Vout is generated on the secondary side of the transformer 22.

The diodes 27, 28 full-wave rectify the AC voltage Vac, to generate a rectified voltage Vrec2. Note that the rectified voltage Vrec2 is applied to a terminal VH of a control IC 32 (described later) included in the control block 26.

The diode 50 rectifies an inductor current IL2 from the secondary coil L2 of the transformer 22, to supply a resultant current to the capacitor 51. Because the capacitor 51 is charged with the current from the diode 50, the output voltage Vout is generated between the terminals of the capacitor 51.

The detection circuit 52 includes, for example, light-emitting diodes 316, 327 (not illustrated in FIG. 1), which will be described below, and the light-emitting diode 316 generates a feedback voltage Vfb (described below) with a phototransistor 38, based on the output voltage Vout. Further, the light-emitting diode 327 generates a voltage Vlat (described below) with a phototransistor 41 (described below), based on a load current Iout. Details of the detection circuit 52 will be described below.

### Overview of control block 26

The control block 26 is a circuit block to control the AC-DC converter 10. The control block 26 includes the power transistor 30, resistors 31, 34, 39, 42, the control IC 32, capacitors 33, 35, 37, 40, 43, a diode 36, and the phototransistors 38, 41.

The power transistor 30 is an N-channel metal–oxide–semiconductor (NMOS) transistor to control the power supplied to the load 11, and controls the inductor current IL1 flowing through the primary coil. Note that in an embodiment of the present disclosure, the power transistor 30 is a Metal Oxide Semiconductor (MOS) transistor, but it is not limited thereto. The power transistor 30 may be other transistors, such as a bipolar transistor and the like, for example, as long as the power transistor 30 is a transistor capable of controlling power.

The resistor 31 is a resistor to detect the inductor current IL1 (for example, the current flowing through the power transistor 30) flowing through the primary coil L1 when the power transistor 30 is on. The resistor 31 has one end connected to the source electrode of the power transistor 30, and the other end that is grounded.

The control IC 32 is an integrated circuit that switches the power transistor 30 to generate the output voltage Vout. Specifically, the control IC 32 switches the power transistor 30, based on the inductor current IL1 and the feedback voltage Vfb.

The control IC 32 has terminals CS, FB, OUT, VCC, LAT and the terminal VH, and details of the control IC 32 will be described below. Note that the power transistor 30 has a gate electrode connected to the terminal OUT, and is switched by a drive voltage Vg. Further, the actual control IC 32 has other terminals as well, however, they are omitted for convenience of explanation. Note that the terminal LAT corresponds to a “first terminal”.

The capacitor 33 is provided between the terminal CS and the ground, and is applied, through the resistor 34, with the voltage across the resistor 31 generated with the inductor current IL1 flowing. The capacitor 33 and the resistor 34 configure a low-pass filter, to stabilize a voltage Vcs at the terminal CS.

The capacitor 35 is provided between the terminal VCC and the ground. The diode 36 has an anode connected to the auxiliary coil L3, and a cathode connected to the terminal VCC.

A voltage Va generated at the auxiliary coil L3 is applied to the capacitor 35 through the diode 36. Note that the capacitor 35, which receives the voltage based on the voltage Va at the auxiliary coil L3 when the power transistor 30 is off, is connected to the terminal VCC, and this voltage results in a power supply voltage Vcc. That is, the power supply voltage Vcc is applied to the capacitor 35.

When the output voltage Vout is maintained at a target level Vout_target, the level of the power supply voltage Vcc is maintained higher than a predetermined level Vclph.

The capacitor 37 is provided between the terminal FB and the ground, to stabilize the voltage Vfb at the terminal FB. The voltage Vfb is a feedback voltage corresponding to the output voltage Vout, and is applied to the terminal FB. The resistor 39 and the capacitor 40 are connected in series between the terminal FB and the ground, and serve as elements for phase compensation.

Note that the control IC 32 turns on the power transistor 30 at a frequency corresponding to the voltage Vfb. Then, in response to the voltage Vcs exceeding the voltage Vfb while the power transistor 30 is on, the control IC 32 turns off the power transistor 30.

The phototransistor 38 is provided between the terminal FB and the ground, to receive the light from the light-emitting diode 316 (describes below). Further, as the intensity of the light emitted by the light-emitting diode 316 increases, the phototransistor 38 flows a larger sink current Ia to the terminal FB. As a result, the voltage Vfb drops.

The resistor 42 is connected in parallel with the phototransistor 41, is supplied with a bias current from a current source 208 (described below) provided in the control IC 32, to generate an intermediate voltage, and applies it to the terminal LAT.

The capacitor 43 is an element to stabilize the voltage applied to the terminal LAT, and is provided between the terminal LAT and the ground.

The phototransistor 41 receives the light from the light-emitting diode 327 (described below) and is provided between the terminal LAT and the ground. Further, in response to the light-emitting diode 327 emitting light, the phototransistor 41 flows a sink current Ib to the terminal LAT, thereby lowering the voltage Vlat.

### Configuration of control IC 32

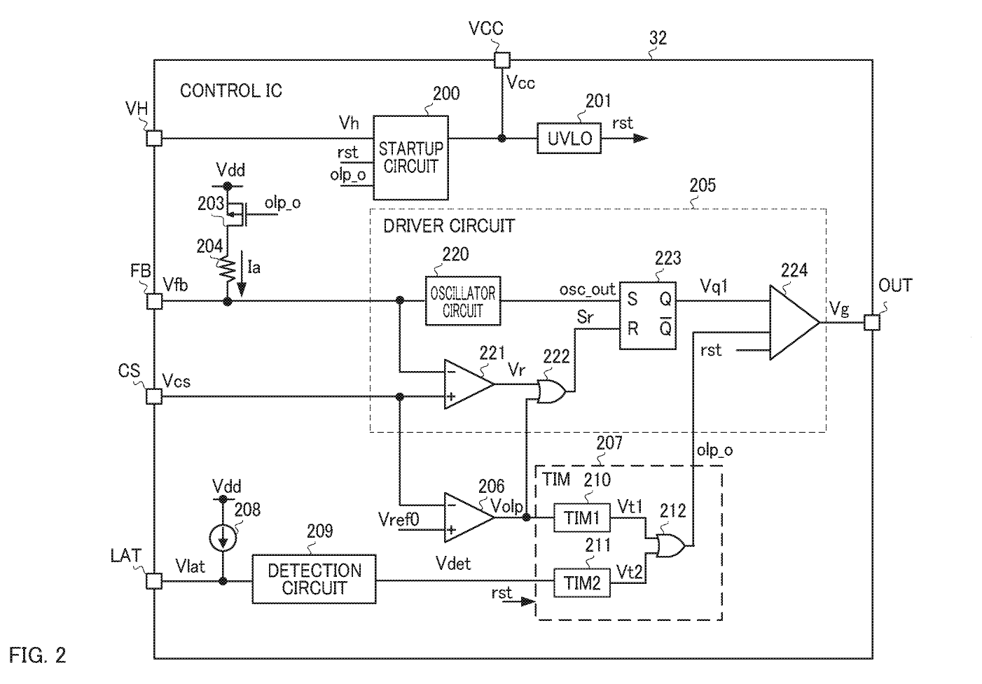

FIG. 2 is a diagram illustrating a configuration example of the control IC 32. The control IC 32 switches the power transistor 30, to thereby generate the output voltage Vout. Specifically, the control IC 32 drives the power transistor 30, based on the voltage Vcs corresponding to the inductor current IL1 and the feedback voltage Vfb. Note that the control IC 32 corresponds to a "switching control circuit".

The control IC 32 includes a startup circuit 200, an under voltage lock out (UVLO) 201, a P-channel metal–oxide–semiconductor (PMOS) transistor 203, a resistor 204, a driver circuit 205, a comparator 206, a timer (TIM) 207, the current source 208, and a detection circuit 209.

### Startup circuit 200

For example, when the under voltage lock out 201 (described below) outputs a signal rst (of a high level (hereafter, referred to as high or high level)) to reset the control IC 32, the startup circuit 200 outputs current to charge the capacitor 35 in FIG. 1 through the terminal VCC, based on a voltage Vh (that is, rectified voltage Vrec2) applied to the terminal VH.

Note that the phrase "reset the control IC 32" refers to stopping the operation of the control IC (here, switching), in response to the high signal rst, so as to prevent the control IC 32 from malfunctioning, when the level of the power supply voltage Vcc is lower than a predetermined level Voff.

Specifically, in response to the voltage Vcc dropping below the predetermined level Voff (for example, upon startup of the control IC 32), the under voltage protection circuit 201 outputs the high signal rst. In this case, the startup circuit 200 outputs current in response to the high reset signal rst. Upon receiving a signal olp_o from the timer 207 described below, the startup circuit 200 outputs current through the terminal VCC, and holds the voltage Vcc at a predetermined level, thereby maintaining the state in which the switching of the power transistor 30 is stopped.

### Under voltage lockout circuit (UVLO) 201

The under voltage lockout circuit 201 outputs the signal rst, based on the power supply voltage Vcc. Specifically, the under voltage lockout circuit 201 outputs the high signal rst to stop switching the power transistor 30, in response to the voltage Vcc reaching the predetermined level Voff.

On the other hand, the under voltage lockout circuit 201 outputs the signal rst of a low level (hereinafter, referred to as low or low level) to allow switching of the power transistor 30, in response to the voltage Vcc reaching a predetermined level Von that is higher than the predetermined level Voff, in the operation of the startup circuit 200.

Further, the driver circuit 205 (described below) stops switching the power transistor 30 upon receiving the high signal rst. On the other hand, upon receiving the low signal rst to allow the switching, the driver circuit 205 controls the switching of the power transistor 30, based on the feedback voltage Vfb and the voltage Vcs.

### PMOS transistor 203

The PMOS transistor 203 is turned off, in response to the timer 207 outputting thereto the high signal olp_o indicating an overload, to thereby stop applying the voltage Vdd from an internal power supply (not illustrated) to the resistor 204.

Thus, the PMOS transistor 203 has a source electrode to receive the voltage Vdd, a gate electrode to receive the signal olp_o, and drain electrode connected to the resistor 204.

Upon a detection of an overload, the switching of the power transistor 30 is stopped, and thus an oscillator circuit 220 (described below) does not need to output an oscillator signal osc_out. In an embodiment of the present disclosure, upon a detection of an overload, the PMOS transistor 203 is turned off, and thus the feedback voltage Vfb results in a ground voltage. As a result, the oscillator circuit 220 decreases a frequency Fsw of the oscillator signal osc_out. This reduces the power consumption of the control IC 32 after an overload is detected.

### Resistor 204

The resistor 204 has one end connected to the drain electrode of the PMOS transistor 203 and the other end connected to the terminal FB. The sink current Ia flows through the resistor 204, and the feedback voltage Vfb corresponding to the output voltage Vout is generated, based on the voltage generated at the resistor 204.

Specifically, upon an increase in the intensity of the light from the light-emitting diode 316, the phototransistor 38 flows the large sink current Ia to the terminal FB. Thus, the voltage generated at the resistor 204 rises, and the feedback voltage Vfb drops.

### Driver circuit 205

The driver circuit 205 generates and amplifies a drive signal, to thereby output the drive voltage Vg. Specifically, the driver circuit 205 outputs the drive voltage Vg, based on the feedback voltage Vfb, the inductor current IL1, and the signal olp_o from the timer 207 (described below). Then, the driver circuit 205 amplifies a drive signal Vq1, to control the switching of the power transistor 30 using the drive voltage Vg.

The driver circuit 205 includes the oscillator circuit 220, a comparator 221, an OR element 222, an SR flip-flop 223, and a buffer 224.

### Oscillator circuit 220

The oscillator circuit 220 generates the timing at which the power transistor 30 is to be turned on. Specifically, the oscillator circuit 220 outputs the oscillator signal osc_out having the frequency Fsw, based on the feedback voltage Vfb. Further, the frequency Fsw of the oscillator signal оsc_оut is usually set to a predetermined frequency Fsw_norm (for example, 100 kHz), and is set so as to decrease with a drop in the feedback voltage Vfb.

### Comparator 221

The comparator 221 produces the timing at which the power transistor 30 is to be turned off. Specifically, the comparator 221 outputs a high signal Vr to turn off the power transistor 30, in response to the voltage Vcs becoming equal to the feedback voltage Vfb when the power transistor 30 is on.

### OR circuit 222

Upon receiving the high signal Vr from the comparator 221 or a high signal Volp from the comparator 206 (described below), the OR element 222 outputs a signal to turn off the power transistor 30.

### SR flip-flop 223

The SR flip-flop 223 outputs the drive signal Vq1. Specifically, upon receiving, from the oscillator circuit 220, the pulsed oscillator signal osc_out to turn on the power transistor 30, the SR flip-flop 223 outputs the high signal Vq1 to turn on the power transistor 30.

On the other hand, upon receiving the high signal from the OR element 222, the SR flip-flop 223 outputs the low signal Vq1 to turn off the power transistor 30. Although being omitted for convenience of explanation, an element that performs a logical AND operation of the signal for determining the maximum on-duty (for example, 0.95) of the power transistor 30 and the signal Vq1 is provided, and thus the buffer 224 does not receive the drive signal having an on-duty exceeding the maximum on-duty.

### Buffer 224

The buffer 224 amplifies the drive signal Vq1 and outputs the drive voltage Vg through the terminal OUT, when the high signal rst or the high signal olp_o is not outputted thereto.

Specifically, when receiving the high signals rst, the buffer 224 outputs the drive voltage Vg that is a ground voltage, resulting in stopping the switching of the power transistor 30.

Further, when receiving the high signal olp_o, the buffer 224 stops the switching of the power transistor 30, as in the case of the signal rst. On the other hand, when receiving neither of the above signals, the buffer 224 performs the switching of the power transistor 30 in response to the drive signal Vq1.

### Comparator 206

The comparator 206 detects whether the inductor current IL1 flowing through the power transistor 30 is greater than the current of a current value I0, to thereby detect whether the load 11 is in the overload state. In other words, the comparator 206 compares the voltage Vcs with a reference voltage Vref0, to thereby detect the state of the load 11.

Specifically, the comparator 206 outputs the high signal Volp, in response to the voltage Vcs exceeding the reference voltage Vref0. Further, the comparator 206 outputs the low signal Volp, when the voltage Vcs is lower than the reference voltage Vref0. The current of the current value I0 corresponds to a "first current", and the comparator 206 corresponds to a "first detection circuit".

### Timer (TIM) 207

To detect an overload, the timer 207 measures the time period during which the high signal Volp is sporadically outputted from the comparator 206 and the time period during which a high signal Vdet is continuously outputted from the detection circuit 209 (described below).

Specifically, the timer 207 outputs and holds the high signal olp_o, in response to the time period during which the high signal Volp is sporadically received in each switching period T corresponding to the frequency Fsw (that is, the time period during which the inductor current IL1 is greater than the current of the current value I0) exceeding the time period P1 (for example, 200 milliseconds). Alternatively, the timer 207 outputs and holds the high signal olp_o, in response to the high signal Vdet being continuously received (that is, the time period during which the load current Iout is greater than the current of the current value I1) exceeding the time period P2 (for example, 5 seconds). Note that the time period P2 is longer than the time period P1, the time period P1 corresponds to a "first time period" and the time period P2 corresponds to a "second time period". Further, the timer 207 corresponds to a "control circuit", and the current of the current value I1 corresponds to a "second current". The timer 207 includes a first timer (TIM1) 210, a second timer (TIM2) 211, and an OR element 212.

The first timer 210 is a timer that measures the time period during which the high signal Volp is sporadically outputted thereto, and outputs and holds a high signal Vt1, in response to this time period exceeding the time period P1, and outputs a low signal Vt1, when this time period does not exceed the time period P1. Further, the second timer 211 is a timer that measures the time period during which the high signal Vdet is continuously outputted thereto, and outputs and holds a high signal Vt2, in response to this time period exceeding the time period P2, and outputs a low signal Vt2, when this time period does not exceed the time period P2. The OR element 212 performs the logical OR operation of the signals Vt1 and Vt2, to thereby output a resultant signal as the signal olp_o. The first timer 210 and the second timer 211 respectively output the low signals Vt1 and Vt2, upon receiving the high signal rst from the under voltage lock out 201. Accordingly, the timer 207 outputs the low signal olp_o, upon receiving the high signal rst from the under voltage lock out 201.

### Current Source 208

The current source 208 supplies the bias current to the terminal LAT (that is, supplies the bias current to the resistor 42 in FIG. 1, which is provided outside of the terminal LAT), to generate an intermediate voltage at the resistor 42. Note the current source 208 corresponds to a "bias current source".

### Detection circuit 209

The detection circuit 209 detects whether the load current Iout flowing through the load 11 is greater than the current of the current value I1. Specifically, the detection circuit 209 outputs the high signal Vdet, in response to the voltage Vlat dropping from the intermediate voltage, based on the sink current Ib flowing through the phototransistor 41 due to the light-emitting diode 327 (described below) being turned on. Note that the detection circuit 209 corresponds to a "second detection circuit".

### Configuration of detection circuit 52

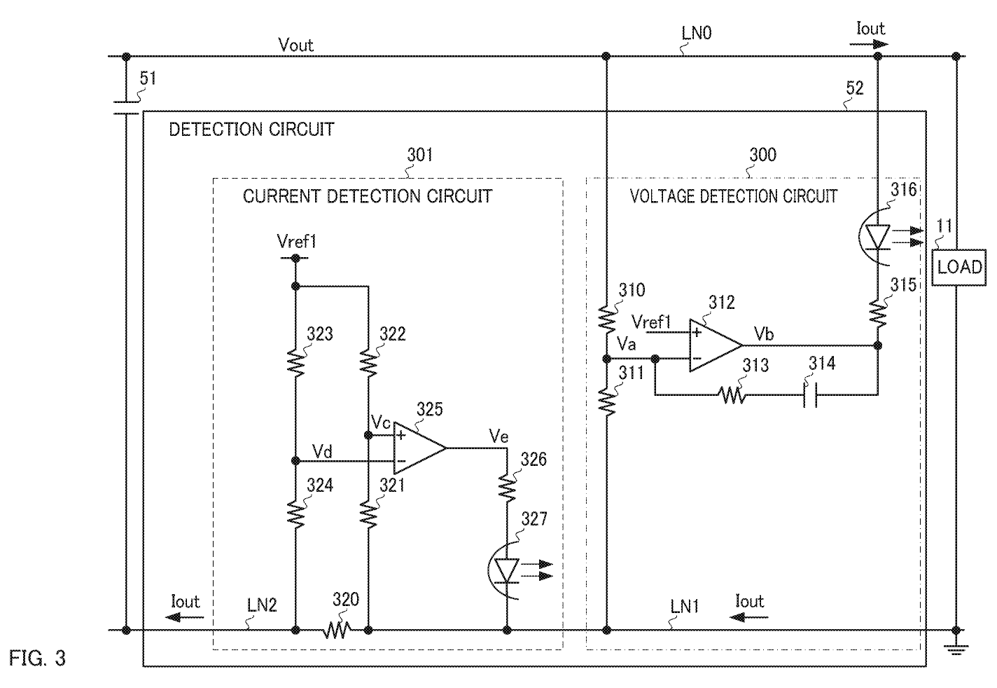

FIG. 3 is a diagram illustrating a configuration example of the detection circuit 52. The detection circuit 52 detects the output voltage Vout and the load current Iout. Then the detection circuit 52 controls the current flowing through the light-emitting diode 316, based on the output voltage Vout. Further, the detection circuit 52 also controls the current flowing through the light-emitting diode 327, based on the load current Iout.

Specifically, the detection circuit 52 increases the intensity of the light emitted by the light-emitting diode 316 more as the output voltage Vout rises higher. Further, the detection circuit 52 increases the intensity of the light emitted by the light-emitting diode 327, in response to the load current Iout increases and the load 11 enters the overload state.

The detection circuit 52 includes a voltage detection circuit 300 and a current detection circuit 301.

### Voltage detection circuit 300

The voltage detection circuit 300 detects the output voltage Vout to control the light emitted by the light-emitting diode 316 so that the output voltage Vout reaches the target level Vout_target.

The voltage detection circuit 300 includes resistors 310, 311, 313, 315, an operational amplifier 312, a capacitor 314, and the light-emitting diode 316. The resistors 310 and 311 configure a voltage divider circuit, and are connected in series between a line LN0 that receives the voltage Vout, and a line LN1 that receives the voltage at the load 11 on the low potential side.

Further, the operational amplifier 312 has an inverting input terminal to receive the voltage Va generated at the connection point between the resistors 310 and 311. Further, the operational amplifier 312 has a non-inverting input terminal to receive the reference voltage Vref1 indicating the voltage that can be taken as the voltage Va when the output voltage Vout is maintained at the target level Vout_target.

The resistor 313 and the capacitor 314 are elements for phase compensation connected in series between the output of the operational amplifier 312 and the inverting input thereof.

The output of the operational amplifier 312 is connected to the resistor 315, and the resistor 315 is connected to the cathode of the light-emitting diode 316. Further, the light-emitting diode 316 has an anode connected to the line LN0. Note that the resistor 315 is an element to limit the current flowing through the light-emitting diode 316.

Accordingly, in response to the output voltage Vout exceeding the target level Vout_target, the voltage Va exceeds the reference voltage Vref1, and the operational amplifier 312 begins to absorb current.

When the light-emitting diode 316 begins to emit light, the phototransistor 38 in FIG. 1 begins to flow the sink current Ia, so that the voltage Vfb drops, which results in a reduction in the inductor current IL1, and thus the output voltage Vout begins to drop.

On the other hand, in response to the output voltage Vout dropping below the target level Vout_target, the voltage Va drops below the reference voltage Vref1 and the operational amplifier 312 stops absorbing the current. Thus, with a reduction in the current flowing via the resistor 315 into the light-emitting diode 316, the light-emitting diode 316 emits low-intensity light, and thus the phototransistor 38 flows the small sink current Ia, so that the voltage Vfb rises.

### Current detection circuit 301

In response to the load 11 entering the overload state and the detected load current Iout exceeding the current of the current value I1, the current detection circuit 301 increases the intensity of the light emitted by the light-emitting diode 327. Note that the load detection circuit 301 corresponds to a "load current detection circuit".

The current detection circuit 301 includes resistors 320 to 324 and 326, a comparator 325, and the light-emitting diode 327.

The resistor 320 has one end connected to the line LN1, and the other end connected to a line LN2 that is connected to the capacitor 51 on the low potential side.

The resistors 321 and 322 are connected in series between the node to receive the reference voltage Vref1 and the line LN1, to thereby configure a voltage divider circuit, and output a voltage Vc at the connection point therebetween.

The resistors 323 and 324 are connected in series between the node to receive the reference voltage Vref1 and the line LN2, to thereby configure a voltage divider circuit, and output a voltage Vd at the connection point therebetween.

Further, the voltage Vc generated at the connection point between the resistors 321 and 322 is applied to the non-inverting input terminal of the comparator 325, and the voltage Vd generated at the connection point between the resistors 323 and 324 is applied to the inverting input terminal of the comparator 325. Note that when the load 11 is in a non-load state, the resistance values of the resistors 321 to 324 are set such that voltage Vd is higher than the voltage Vc.

Then, an output voltage Ve of the comparator 325 is applied to the resistor 326, which is connected to the anode of the light-emitting diode 327. The cathode of the light-emitting diode 327 is grounded. That is, the comparator 325 outputs, as the output voltage Ve, a result of magnitude comparison between the load current Iout and the current of the current value I1. Note that the resistor 326 is an element to limit the current flowing through the light-emitting diode 327. Further, the comparator 325 corresponds to a "comparator circuit", and the output voltage Ve corresponds to a "first voltage".

In an embodiment of the present disclosure, in response to the load current Iout greater than the current of the current value I1, which indicates that the load 11 is in the overload state, flowing through the resistor 320, the voltage Vd drops below the voltage Vc. As a result, the comparator 325 outputs the high voltage Ve. Then, the light-emitting diode 327 emits light, and the phototransistor 41 in FIG. 1 flows the sink current Ib. Thus, the voltage Vlat at the terminal LAT results in the ground voltage. Note that the high level corresponds to a "first level", and the low level corresponds to a "second level".

Meanwhile, when the load 11 is in the no-load state (that is, the load current Iout is smaller than the current of the current value I1), the load current Iout does not flow through the resistor 320, and thus the voltage Vd rises above the voltage Vc, and the comparator 325 outputs the low voltage Ve. Then, the light-emitting diode 327 does not emit light, and the phototransistor 41 does not flow the sink current Ib. Thus, the voltage Vlat at the terminal LAT results in the intermediate voltage. Further, the time period during which the output voltage Ve changes from low to high is shorter than the time period P1.

Note that the phrase "the load 11 is in a light load state" refers to, for example, the case in which the current value of the load current Iout flowing through the load 11 is smaller than a predetermined value (for example, 1 A). Further, "the load 11 is in a heavy load state" refers to, for example, the case in which the current value of the load current Iout flowing through the load 11 is greater than the predetermined value (for example, 1 A).

Further, the phrase "the load 11 is in the overload state" refers to the case in which the current value of the load current Iout flowing through the load 11 is equal to or greater than 5 A, for example. Furthermore, the phrase "the load 11 is in the no-load state" refers to the case in which the current value of the load current Iout flowing through the load 11 is extremely small or 0 (zero) A.

A description has been given such that the current value of the load current Iout to determine whether the load 11 is in the heavy load state or the light load state is, for example, 1 A; however, this current value may be set to various values. A description has been given such that the current value of the load current Iout to determine whether the load 11 is in the overload state is, for example, 5 A; however, this current value may be set to various values.

### Operations of comparator 206 and timer 207

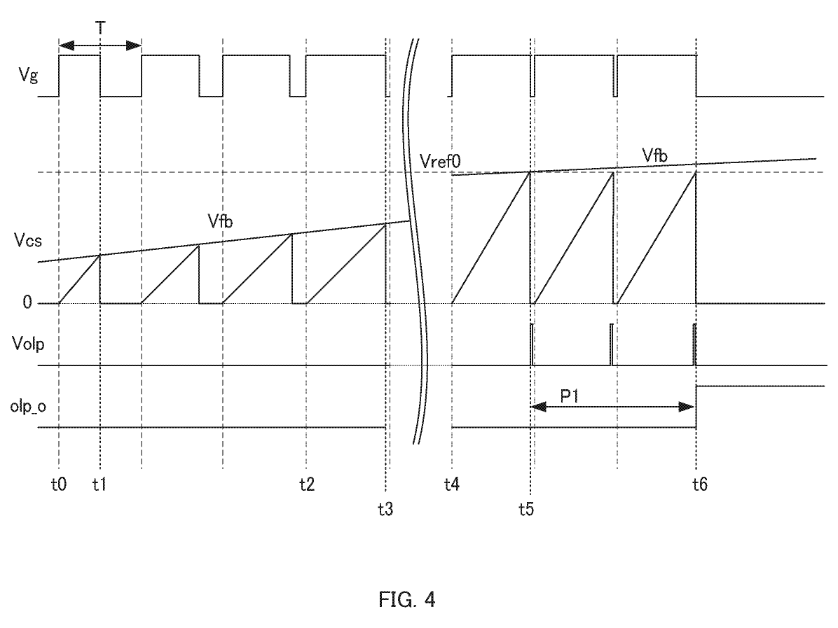

FIG. 4 is a diagram illustrating an operation example of the comparator 206 and the timer 207. Specifically, FIG. 4 illustrates the operation when the load 11 changes from the light load state to the heavy load state. Note that the vertical lines given by the dashed lines in the drawing indicates the period T corresponding to the frequency Fsw of the oscillator signal оsc_оut outputted by the oscillator circuit 220. Further, it is assumed that before time t0, the rectified voltage Vrec2 is applied to the terminal VH, the startup circuit 200 raises the power supply voltage Vcc, and the under voltage lock out 201 outputs the low signal rst.

At time t0, the control IC 32 outputs the drive voltage Vg to turn on the power transistor 30. In response to turning on of the power transistor 30, the voltage Vcs begins to rise.

In response to the voltage Vcs becomes equal to the voltage Vfb at time t1, the control IC 32 outputs the drive voltage Vg to turn off the power transistor 30. The same operation is repeated therefrom until time t2.

At time t2, because the period T has elapsed since previously turning on of the power transistor 30, the control IC 32 outputs the drive voltage Vg to turn on the power transistor 30. In response to turning on of the power transistor 30, the voltage Vcs begins to rise.

In response to the voltage Vcs becoming equal to the voltage Vfb at time t3, the control IC 32 outputs the drive voltage Vg to turn off the power transistor 30. It is assumed that in this event, it reaches the maximum on-duty (for example, 0.95) of the power transistor 30.

Furthermore, at time t4 at which the load 11 enters the heavy load state, the control IC 32 outputs the drive voltage Vg to turn on the power transistor 30. In response to turning on of the power transistor 30, the voltage Vcs begins to rise.

In response to the voltage Vcs becoming equal to the reference voltage Vref0 at time t5, the comparator 206 in FIG. 2 outputs the high signal Volp. Then, the control IC 32 turns off the power transistor 30. The timer 207 then begins to measure the time period P1. Hereinafter, the same operation is repeated until time t6.

From time t5, the high signal Volp is sporadically received, and at time t6 at which the time period P1 has elapsed, the timer 207 outputs the high signal olp_o, because the time period during which the high signal Volp is sporadically outputted has continued for the time period P1. Thus, the buffer 224 stops switching the power transistor 30.

Thereafter, in response to the rectified voltage Vrec2 being reapplied to the terminal VH, the startup circuit 200 raises the power supply voltage Vcc and the under voltage lock out 201 outputs the low signal rst, thereby resuming the operation of the control IC 32.

### Operations of light-emitting diode 327 and phototransistor 41

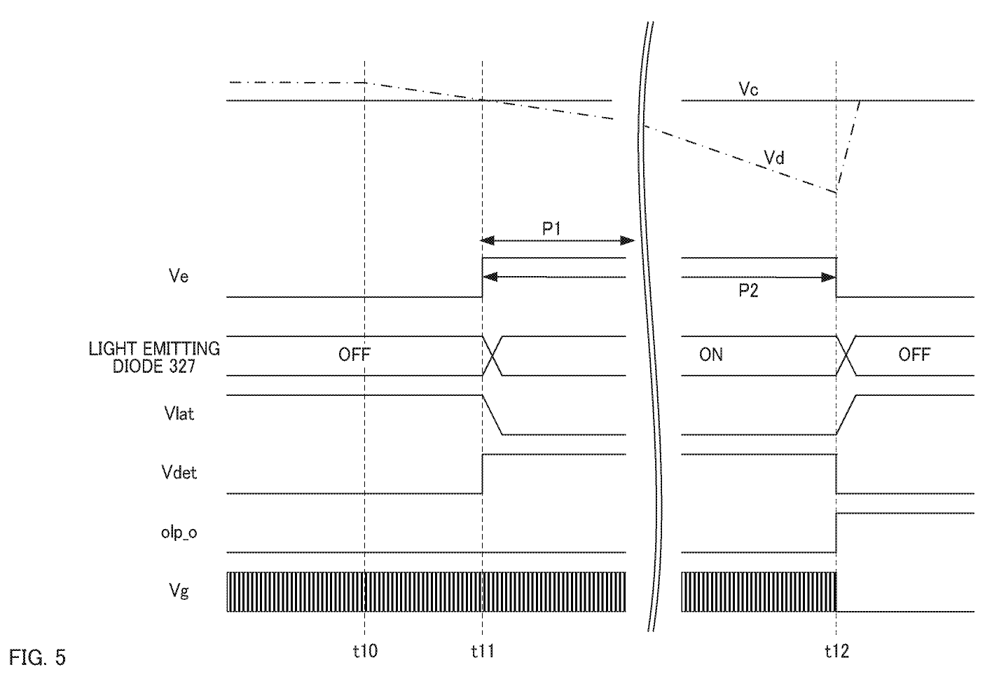

FIG. 5 illustrates an operation example of the light-emitting diode 327 and the phototransistor 41. It is assumed that before time t10, the load 11 is in the no-load state and the light-emitting diode 327 is off. Further, It is assumed that before time t10, the rectified voltage Vrec2 is applied to the terminal VH, the startup circuit 200 raises the power supply voltage Vcc and the under voltage lock out 201 outputs the low signal rst.

At time t10, the load 11 enters the heavy load state, and thus the current flowing through the resistor 320 in FIG. 3 increases and the voltage generated at the resistor 320 increases as well. Thus, the voltage Vd begins to drop.

In response to the voltage Vd dropping below the voltage Vc at time t11, the comparator 325 outputs the high signal Ve. Then, the light-emitting diode 327 is turned on. In response to the light-emitting diode 327 being turned on, the phototransistor 41 flows the sink current Ib and the voltage Vlat results in the ground voltage. Then, the detection circuit 209 detects that the voltage Vlat has dropped from the intermediate voltage, and outputs the high signal Vdet. The timer 207 then begins to measure the time period P2.

At time t12 at which the time period P2 has elapsed since time t11, the timer 207 outputs the high signal olp_o, because the time period during which the high signal Vdet is continuously outputted has continued for the time period P2. Thus, the buffer 224 stops switching the power transistor 30.

Thereafter, in response to the rectified voltage Vrec2 being reapplied to the terminal VH, the startup circuit 200 raises the power supply voltage Vcc and the under voltage lock out 201 outputs the low signal rst, thereby resuming the operation of the control IC 32.

This makes it possible to provide the switching control circuit capable of reducing the circuit size of the power supply circuit.

### Summary

A description has been given of the AC-DC converter 10 according to an embodiment of the present disclosure. The control IC 32 includes the driver circuit 205, the comparator 206, the detection circuit 209, and the timer 207. The time period P2 is measured by the timer 207. This makes it possible to provide the switching control circuit capable of reducing the size of the power supply circuit.

The AC-DC converter 10 includes the transformer 22, the power transistor 30, and the control IC 32, and the control IC 32 includes the driver circuit 205, the comparator 206, the detection circuit 209, and the timer 207. The time period P2 is measured by the timer 207. This makes it possible to provide the switching control circuit capable of reducing the circuit size of the power supply circuit.

The AC-DC converter 10 further includes the current detection circuit 301, and the current detection circuit 301 includes the comparator 325, and the light-emitting diode 327, and the control IC 32 includes terminals LAT and the current source 208 Accordingly, the time period P2 is measured by the timer 207, and thus the AC-DC converter 10 can reduce the time delay in the detection circuit 52 on the secondary side.

The present disclosure is directed to provision of a switching control circuit capable of reducing the circuit size of a power supply circuit.

According to the present disclosure, it is possible to provide a switching control circuit capable of reducing the circuit size of a power supply circuit.

An embodiment of the present disclosure described above is simply to facilitate the understanding of the present disclosure and is not in any way to be construed as limiting the present disclosure. The present disclosure may variously be changed or altered without departing from its essential features and encompass equivalents thereof.

What is claimed is:

1. A switching control circuit for a power supply circuit that generates an output voltage at a target level from an input voltage inputted thereto, the power supply circuit having a load, the power supply circuit including
a transformer including a primary coil and a secondary coil, and
a transistor configured to control an inductor current flowing through the primary coil,
the switching control circuit being configured to drive the transistor, the switching control circuit comprising:
a driver circuit configured to drive the transistor, based on a feedback voltage corresponding to the output voltage and a current flowing through the transistor;
a first detection circuit configured to detect whether the current flowing through the transistor is greater than a first current;
a second detection circuit configured to detect whether a load current flowing through the load of the power supply circuit is greater than a second current; and
a control circuit configured to control the driver circuit so as to stop switching the transistor, in response to
a state in which the current flowing through the transistor is greater than the first current having continued for a first time period, or
a state in which the load current is greater than the second current having continued for a second time period longer than the first time period.

2. A power supply circuit configured to generate an output voltage at a target level from an input voltage inputted thereto, the power supply circuit having a load, the power supply circuit comprising:
a transformer including a primary coil and a secondary coil;
a transistor configured to control an inductor current flowing through the primary coil;
a switching control circuit configured to drive the transistor, the switching control circuit including
a driver circuit configured to drive the transistor, based on a feedback voltage corresponding to the output voltage and a current flowing through the transistor,
a first detection circuit configured to detect whether the current flowing through the transistor is greater than a first current, and
a second detection circuit configured to detect whether a load current flowing through the load of the power supply circuit is greater than a second current,
a control circuit configured to control the driver circuit so as to stop switching the transistor, in response to
a state in which the current flowing through the transistor is greater than the first current having continued for a first time period, or
a state in which the load current is greater than the second current having continued for a second time period longer than the first time period.

3. The power supply circuit according to claim 2, further comprising:
a load current detection circuit configured to detect the load current, wherein
the switching control circuit is an integrated circuit,
the load current detection circuit includes
a comparator circuit configured to output a first voltage indicating a result of comparison between a magnitude of the load current and that of the second current, and
a light-emitting diode connected to an output of the comparator circuit,
the comparator circuit being so configured that the outputted first voltage is:
at a first level so as to turn on the light-emitting diode, when the load current is greater than the second current, and
at a second level so as to turn off the light-emitting diode, when the load current is smaller than the second current, and
the integrated circuit includes
a first terminal, and
a bias current source configured to supply a bias current to the first terminal,
the first terminal being connected with
a phototransistor configured to receive light from the light-emitting diode, and
a resistor connected in parallel with the phototransistor; and
a time period during which the first voltage changes from the second level to the first level is shorter than the first time period.
